(19) United States
(12) Patent Application Publication
(10) Pub. No.: US 2003/0059271 A1
(43) Pub. Date: Mar. 27, 2003

(54) Expansion bolt assembly

(76) Inventor: Ping-Kuei Chou, Taipei (TW)

Correspondence Address: VENABLE, BAETJER, HOWARD AND CIVILETTI, LLP, P.O. BOX 34385, WASHINGTON, DC, 20043-9998, US

(21) Appl. No.: 09/983,052

(22) Filed: Sep. 25, 2001

(51) Int. Cl. F16B 13/06

(52) U.S. Cl. 411/54.1

(57) ABSTRACT

An expansion bolt assembly has a bolt, a sleeve and a nut. The bolt has a conical head formed at one end of the bolt and a non-circular recess defined in the other end of the bolt. The recess is adapted for a tool to engage the recess to keep the bolt from rotating. The sleeve is slidably mounted around the bolt. Multiple slits are defined in the sleeve at an end facing the conical head on the bolt. The nut is screwed onto the bolt and abuts the sleeve to push the sleeve relative to the bolt. With such an expansion bolt, the bolt does not move during the installation of the expansion bolt. The expansion bolt can be used with a shallow hole. The scope in which the expansion bolt can be used is enlarged.

### BACKGROUND OF THE INVENTION

1. Field of the Invention

The present invention relates to an expansion bolt assembly, and more particularly to an expansion bolt that can used in a shallow hole so as to enlarge the scope in which the expansion bolt can be used.

2. Description of Related Art

With reference to FIG. 8, a conventional expansion bolt in accordance with the prior art comprises a bolt (40), a sleeve (42) and a nut (44). The bolt (40) has a conical head (402) formed on one end of the bolt (40). The sleeve (42) is slidably mounted around the bolt (40). Multiple slits (422) are defined in the sleeve (42) at one end facing the head (402) of the bolt (40), such that multiple clawing portions are formed on the end of the sleeve (42). The nut (44) is screwed onto the bolt (40).

To use the expansion bolt, a hole is first defined in a wall or a body. The end of the bolt (40) with the head (402) is inserted into the hole, and the other end of the bolt (40) is exposed from the hole. The sleeve (42) is mounted around the bolt (40) and inserted into the hole. When the nut (44) abuts the wall or the body defining the hole and continues to be screwed onto the bolt (40), the bolt (40) will be pulled out of the hole due to the engagement with the nut (44). The conical head (402) of the bolt (40) will expand the clawing portions on the sleeve (42), and the clawing portions will securely engage with the inner surface of the hole. Consequently, the expansion bolt is secured to the wall, and the exposed portion of the bolt (40) can be used to hang an object on the wall.

However, the bolt (40) of the conventional expansion bolt moves out from the hole in the wall as the conventional expansion bolt is secured to the wall. A gap will be defined between the head (402) of bolt (40) and the face defining the hole. Therefore, a hole with a deep depth is needed to accommodate the movement of the bolt (40). The conventional expansion bolt cannot be used in a thin wall because a deep hole easily causes damage to or cracks in a thin wall. The scope in which the conventional expansion bolt can be used is limited.

With reference to FIG. 9, another conventional expansion bolt in accordance with the prior art comprises a bolt (50) and a nut (52). The bolt (50) has a conical head (502) formed on one end of the bolt (50). The nut (52) has a sleeve (522) integrally formed on the nut (52). An inner thread is defined on the inner surface of the nut (52) and the sleeve (522) to screw onto the bolt (50). Multiple slits (524) are defined in the sleeve (522) at one end opposite from the nut (52), such that multiple clawing portions are formed on the end of the sleeve (522). In use, the end of the bolt (50) with the head (502) is inserted into a hole defined in a wall, and the other end of the bolt (50) is exposed from the hole. The nut (52) with the sleeve (522) is screwed onto the bolt (50), and the sleeve (522) is received in the hole. When the nut (52) abuts the wall defining the hole and continues to be screwed into the bolt (50), the bolt (50) will be pulled out of the hole due to the engagement with the inner thread in the nut (52). The conical head (502) of the bolt (50) will expand the clawing portions on the sleeve (522), and the clawing portions will securely engage with the inner surface of the hole. Consequently, the expansion bolt is secured to the wall, and the exposed portion of the bolt (50) can be used to hang an object on the wall.

However, the bolt (50) of the conventional expansion bolt also moves out from the hole in the wall as the conventional expansion bolt is secured to the wall. This embodiment of the conventional expansion bolt cannot be used in a thin wall, either. In addition, to form a nut (52) with a long sleeve (522) having an inner thread and slits (524) is very difficult. The cost for manufacturing the conventional expansion bolt is expansive. Furthermore, because the sleeve (522) is integrally formed on the nut (52), the sleeve (52) will rotate with the nut (52). When the clawing portions expand, the sleeve (522) simultaneously rotates. This will generate a large friction force on the sleeve (522) so that rotating the nut will be very difficult.

To overcome the shortcomings, the present invention tends to provide an improved expansion bolt to mitigate or obviate the aforementioned problems.

### SUMMARY OF THE INVENTION

The main objective of the invention is to provide an improved expansion bolt assembly that can be used with a shallow hole to enlarge the scope in which the expansion bolt can be used. The expansion bolt has a bolt, a sleeve and a nut. The bolt has a conical head formed at one end of the bolt and a non-circular recess defined in the other end of the bolt. The recess is adapted for a tool to engage the recess to keep the bolt from rotating. The sleeve is slidably mounted around the bolt. Multiple slits are defined in the sleeve at an end facing the head on the bolt. The nut is screwed onto the bolt and abuts the sleeve to push the sleeve relative to the bolt. With such an expansion bolt, the bolt does not move during the installation of the expansion bolt. The expansion bolt can be used with a shallow hole. The scope in which the expansion bolt can be used is enlarged.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of an expansion bolt in accordance with the present invention;

FIG. 2 is a side plan view in partial section of the expansion bolt in FIG. 1 showing the expansion bolt inserted into a hole in a wall;

FIG. 3 is a side plan view in partial section of the expansion bolt in FIG. 1 showing the sleeve being pushed and expanded to engage with the wall;

FIG. 4 is an operational perspective view of of the expansion bolt in FIG. 1 used to hang a bracket on a wall;

FIG. 5 is a perspective view of another embodiment of the nut of the expansion bolt in FIG. 1

FIG. 6 is an exploded perspective view of a second embodiment of an expansion bolt in accordance with the present invention;

FIG. 7 is an exploded perspective view of a third embodiment of an expansion bolt in accordance with the present invention;

FIG. 8 is a side plan view in partial section of a conventional expansion bolt in accordance with the prior art mounted on a wall; and

FIG. 9 is a side plan view in partial section of another conventional expansion bolt in accordance with the prior art mounted on a wall.

### DETAILED DESCRIPTION OF PREFERRED EMBODIMENT

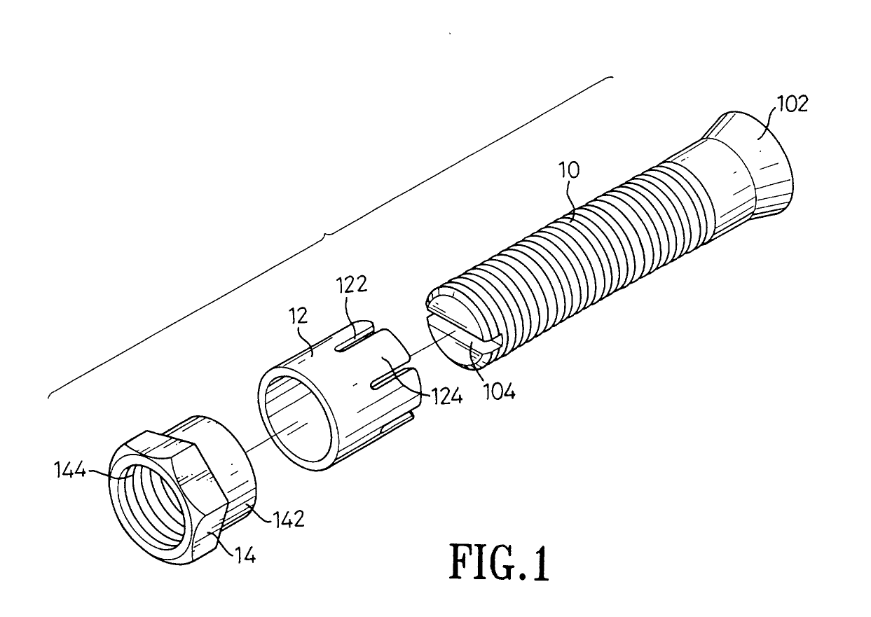

With reference to FIG. 1, an expansion bolt in accordance with the present invention comprises a bolt (10), a sleeve (12) and a nut (14). The bolt (10) has two ends, and a conical head (102) is formed on one end of the bolt (10). A non-circular recess (104) is defined in the other end of the bolt (10) for a tool like a screwdriver or a wrench to engage the recess (104) and keep the bolt (10) from rotating.

The sleeve (12) is slidably mounted around the bolt (10). Multiple slits (122) are defined in the sleeve (12) at one end facing the conical head (102) of the bolt (10), such that multiple clawing portions (124) are formed on the end of the sleeve (12).

The nut (14) is screwed onto the bolt (10). A tube (142) is integrally formed on the nut (14) to abut the sleeve (12). An inner thread (144) is defined through the nut (14) and the sleeve (142) to engage the bolt (10).

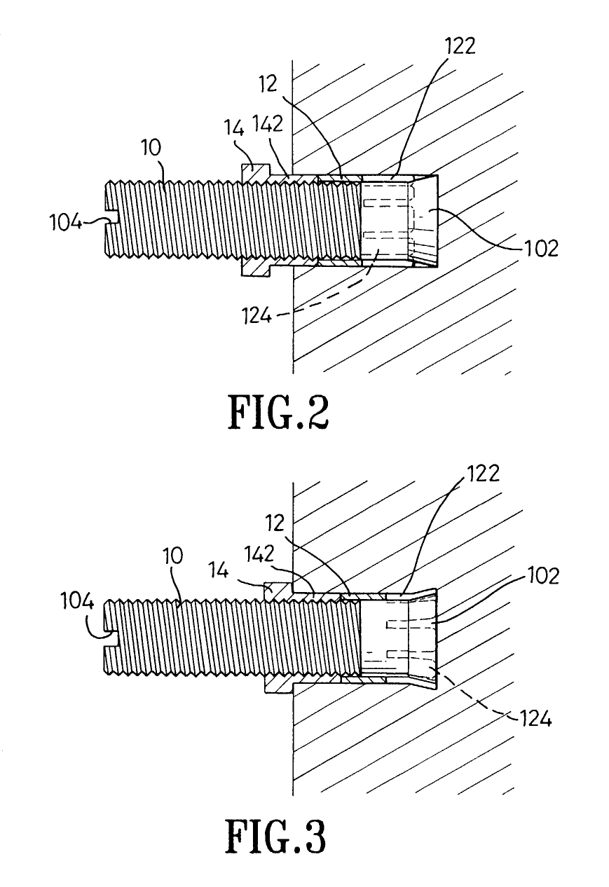

With reference to FIGS. 1 to 3, to use the expansion bolt, a hole is first defined in a wall or a body. The end of the bolt (10) with the conical head (102) is inserted into the hole, and the other end of the bolt (10) is exposed from the hole. The sleeve (12) is inserted around the bolt (10) into the hole. The nut (14) with the tube (142) is screwed onto the bolt (10). A tool engages the noncircular recess (104) in the bolt (10) to keep the bolt (10) from rotating.

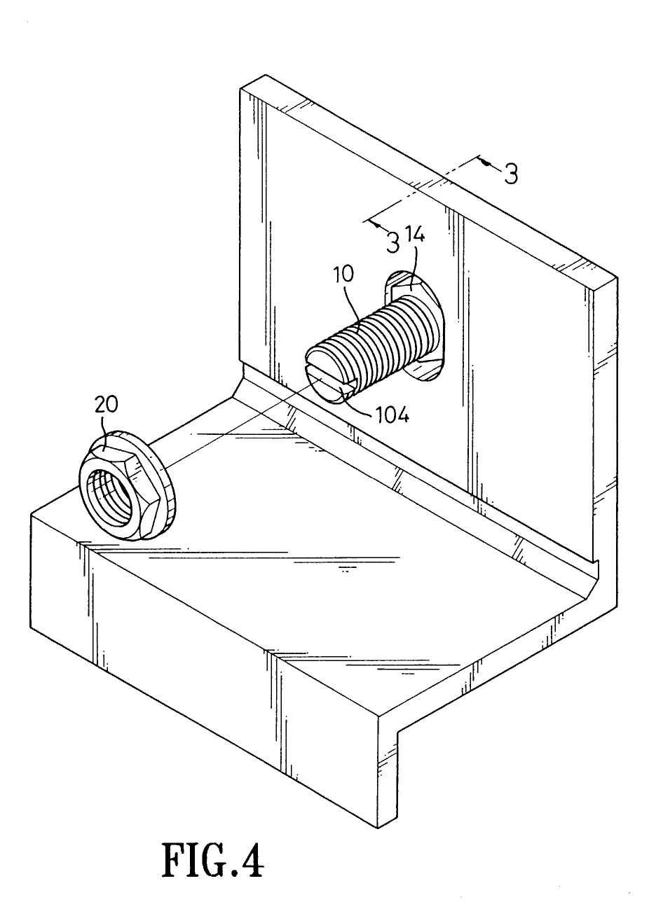

When the tube (142) on the nut (14) abuts the sleeve (12) and the nut (14) continues to be rotated, the sleeve (12) will be pushed inward relative to the hole. The conical head (102) of the bolt (10) will expand the clawing portions (124) on the sleeve (12), and the clawing portions (124) will securely engage with the inner surface of the hole. Consequently, the expansion bolt is secured to the wall, and the exposed portion of the bolt (10) can be used to hang an object on the wall with assistance of a nut (20) as shown in FIG. 4.

Because the bolt (10) does not move during the placement of the expansion bolt, the expansion bolt can be used with a shallow hole. The scope in which the expansion bolt can be used is enlarged.

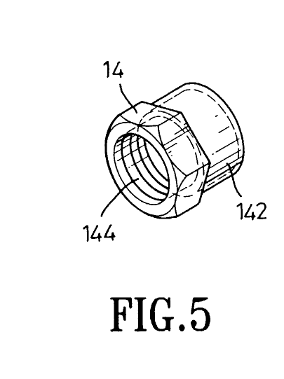

With reference to FIG. 5, the inner thread (144) in another embodiment of the nut (14) is only defined in the nut (14) but not in the tube (142). The structure and manufacture of the nut (14) with the tube (142) can be simplified.

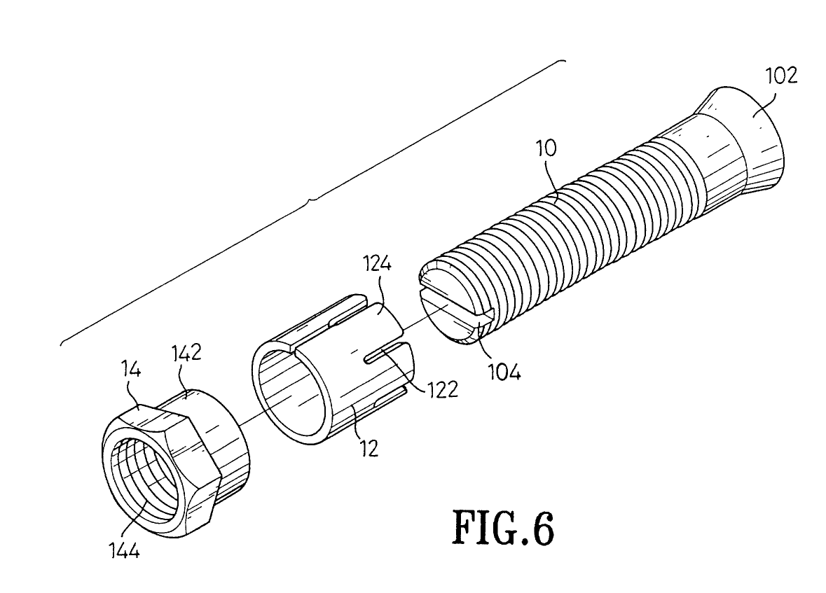

With reference to FIG. 6, another embodiment of the sleeve (12) is made from a metal strip. Multiple slits (122) are formed at one side of the metal strip. The strip is then cut into multiple pieces at a desired length. A sleeve (12) is formed by bending each strip into a cylinder. This can simplify the manufacturing process of the sleeve (12) with slits (122) and clawing portions (124).

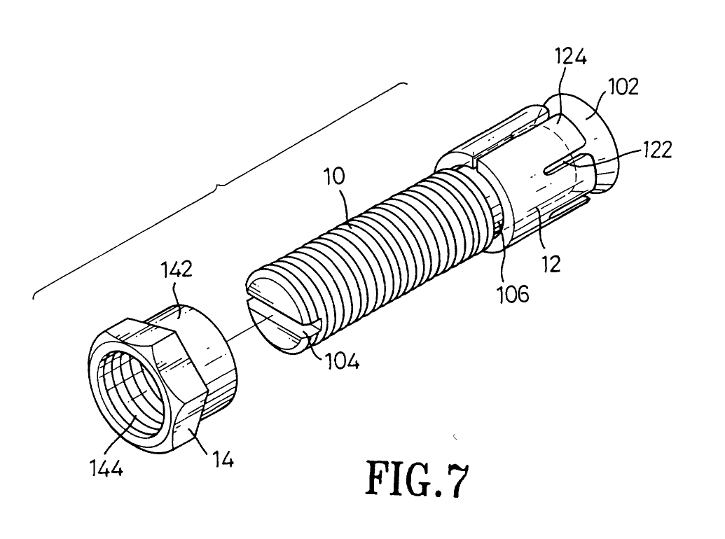

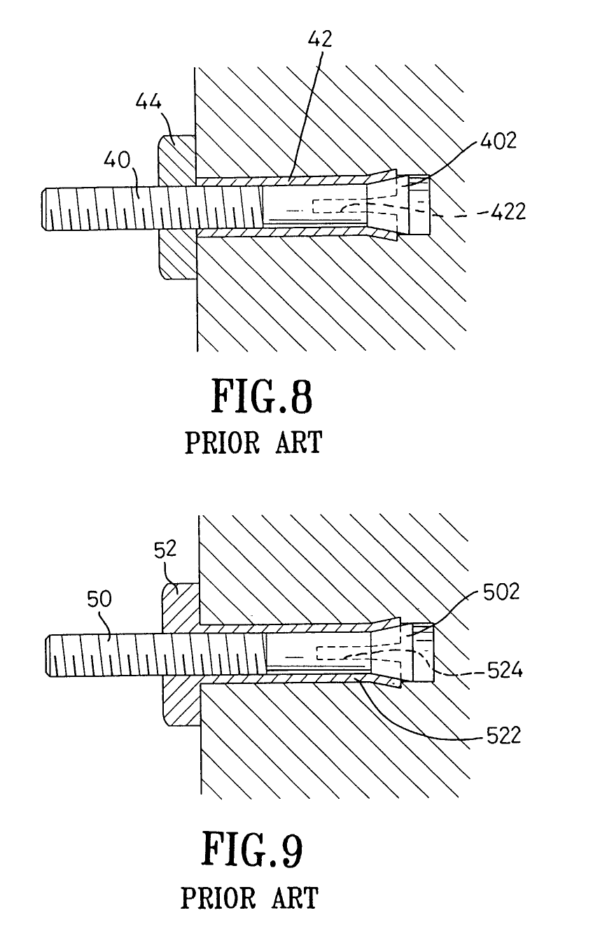

With reference to FIG. 7, in another embodiment of the expansion bolt, a neck (106) with a diameter smaller than that of the bolt (10) is formed between the bolt (10) and the head (102). The sleeve (12) made from a metal strip is slidably mounted around the neck (106). Accordingly, the strip can be directly bent around the neck (106) to form a sleeve (12) around the bolt (10). To manufacture the expansion bolt can be further simplified.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An expansion bolt assembly comprising:
a bolt having a conical head formed at one end of the bolt and a noncircular recess defined in the other end of the bolt and adapted for a tool to engage the recess to keep the bolt from rotating;
a sleeve slidably mounted around the bolt and having multiple slits peripherally defined through the sleeve at an end facing the conical head on the bolt to form multiple clawing portions on the end of the sleeve; and
a nut screwed on the bolt and abutting the sleeve to push the sleeve relative to the bolt.

2. The expansion bolt as claimed in claim 1 further comprising a tube integrally extending from the nut and abutting the sleeve to push the sleeve.

3. The expansion bolt as claimed in claim 1, wherein the nut has an inner thread defined in the nut to screw onto the bolt.

4. The expansion bolt as claimed in claim 3, wherein the inner thread in the nut extends through the tube.

5. The expansion bolt as claimed in claim 1, wherein the sleeve is made of a metal strip.

6. The expansion bolt as claimed in claim 5 further comprising a neck with a diameter smaller than that of the bolt formed between the bolt and the head for the sleeve made of a metal strip to be mounted around the neck.
